(19) United States
(12) Patent Application Publication
(10) Pub. No.: US 2007/0027932 A1
(43) Pub. Date: Feb. 1, 2007

(54) SYSTEM AND METHOD OF CREATING A SINGLE SOURCE RSS DOCUMENT FROM MULTIPLE CONTENT SOURCES

(75) Inventor: Jason Thibeault, Chandler, AZ (US)

Correspondence Address: ZARETSKY & ASSOCIATES PC, 8753 W. RUNION DR., PEORIA, AZ, 85382-6412, US

(73) Assignee: Q2 Labs, LLC

(21) Appl. No.: 11/460,036

(22) Filed: Jul. 26, 2006

Related U.S. Application Data
(60) Provisional application No. 60/703,702, filed on Jul. 29, 2005.

(51) Int. Cl. G06F 17/30; G06F 12/00

(52) U.S. Cl. 707/200

(57) ABSTRACT

A novel system and method for aggregating multiple really simple syndication (RSS) documents and non-RSS document content sources into a single master RSS document. An aggregation application identifies the particular elements in each RSS document and content sources to be aggregated into the master RSS document. A user indicates the specific content sources and RSS documents to be included and any filtering criteria to be applied to the content sources and/or RSS documents. The resulting collection of items are stored and combined to generate the master RSS document. RSS documents are generated from non-RSS document content sources. The aggregation application examines the document and attempts to identify elements therein. For each element identified, the aggregation application ‘highlights’ the corresponding document code as a content element. The aggregation application renders the document through a GUI. A user customizes the content of the target RSS document by selecting items to be represented in RSS format. The selected content is aggregated together and used to generate the master RSS document.

### REFERENCE TO PRIORITY APPLICATION

This application claims priority under 35 U.S.C. § 119(e) to U.S. Provisional Application Ser. No. 60/703,702, filed Jul. 29, 2005, entitled “System And Method of Creating A Single Source RSS Document From Multiple Content Sources,” incorporated herein by reference in its entirety.

### FIELD OF THE INVENTION

The present invention relates to the field of data communications and more particularly relates to a system and method of generating a single master Really Simple Syndication (RSS) protocol based document from multiple content sources.

### BACKGROUND OF THE INVENTION

In recent years the number of computers in use is increasing at an ever quickening pace. Along with the huge increase in the number of computers in use around the world, is a parallel increase in the number of computers connected to the Internet. Further, the world is witnessing an explosion of wireless devices that have the capability of connecting to the Internet as well. Such wireless devices include, for example, laptop computers, notebooks, palmtops, PDAs, cellular telephones with email and web browsing capabilities and other mobile wireless devices.

The Really Simple Syndication (RSS) format is widely used today to represent documents for delivery to a target or client computing device. It is commonly used by news organizations to distribute news feeds to a large number of subscribers or ‘bloggers’ to provide a mechanism for their readers to receive timely updates without having to frequently visit the blog site itself. Rather than requiring users to click on individual items at a news website, users subscribe to an RSS news feed. Once subscribed, users are automatically sent a copy of the news item when it is published by the news server.

Every object that can be identified through a Uniform Resource Identifier (URI) or Uniform Resource Locator (URL) is a resource that can be embedded in an RSS document. An RSS document contains information about which information objects are to be found under a URI. In addition, it can include a description of the resource and the individual information objects, the specification of a unique identifier for the objects and other information.

With the proliferation of RSS subscribers and corresponding RSS feeds, it is often desirable to be able to combine several RSS documents into a single RSS document. Further, in the case of non-RSS documents, it would be desirable to be able to combine content sources and/or RSS documents into a single RSS document.

There is thus a need for a mechanism that overcomes the disadvantages of the prior art. In particular, there is a need for a mechanism that is capable of combining several RSS documents into a single RSS document thereby allowing the user the ability to select individual elements from multiple feeds to create a single, customized targeted feed. Furthermore, there is a need to be able to combine both non-RSS documents from different content sources and RSS documents into a single RSS document.

### SUMMARY OF THE INVENTION

The present invention is a system and method for combining or aggregating multiple RSS documents into a single master RSS document. The source RSS documents may include non-RSS documents from any content source. The invention provides a mechanism for converting non-RSS documents into RSS documents for inclusion in the single master RSS document. Any number and combination of RSS documents or content sources can be aggregated into the single master RSS document. Furthermore, the mechanism provides a user the capability of selecting individual elements from within the source RSS documents, thereby creating a master RSS document that is highly customized and specific.

The aggregation application of the present invention provides a mechanism to identify the particular elements in each of the content sources and RSS documents that are to be aggregated into the master RSS document. The aggregation application provides a means for a user to indicate (1) the specific content sources and RSS documents to be included and (2) any filtering criteria to be applied to the content sources and/or RSS documents. This data is stored in a user content configuration database. The result is a collection of items that are stored in memory until the selection process is completed.

Once the user completes the selection process, the items stored in memory are retrieved and aggregated (i.e. combined or consolidated) into the master RSS document. After all items are inserted and the master RSS document is generated, the user can elect to publish it or store it locally for future use.

The aggregation application also provides a mechanism to generate RSS documents from non-RSS document content sources. In this case, the aggregation application fetches the non-RSS document and attempts to identify elements within the document. For each element identified, the aggregation application “highlights” the corresponding document code as a content element. The aggregation application then renders the document through a GUI whereby a user selects items they want represented in RSS format. Once selection is complete, the aggregation application generates an RSS representation of the items. The RSS representation of the items is then stored for subsequent insertion into the master RSS document.

Note that some aspects of the invention described herein may be constructed as software objects that are executed in embedded devices as firmware, software objects that are executed as part of a software application on either an embedded or non-embedded computer system such as a central processing unit (CPU), digital signal processor (DSP), microcomputer, minicomputer, microprocessor, etc. running a real-time operating system such as WinCE, Symbian, OSE, Embedded LINUX, etc. or non-real time operating system such as Windows, UNIX, LINUX, etc., or as soft core realized HDL circuits embodied in an Application Specific Integrated Circuit (ASIC) or Field Programmable Gate Array (FPGA), or as functionally equivalent discrete hardware components.

There is thus provided in accordance with the invention, a method of aggregating a plurality of content sources into a single master Really Simple Syndication (RSS) document, the method comprising the steps of retrieving a plurality of content sources, scanning each content source against user content configuration data to extract one or more items therefrom, storing each item extracted in memory and combining the items stored in memory into a single master RSS document.

There is also provided in accordance with the invention, a method of combining a plurality of Really Simple Syndication (RSS) documents into a single master RSS document, the method comprising the steps of retrieving a plurality of RSS documents, scanning each RSS document to extract one or more items therefrom utilizing user content configuration data to indicate the information to be extracted and combining the extracted items into a single master RSS document.

There is further provided in accordance with the invention, a computer program product comprising a computer usable medium having computer usable program code for combining a plurality of Really Simple Syndication (RSS) documents into a single master RSS document, the computer program product including, computer usable program code for retrieving a plurality of RSS documents, computer usable program code for scanning each RSS document to extract one or more items therefrom utilizing user content configuration data to indicate the information to be extracted and computer usable program code for combining all extracted items into a single master RSS document.

There is also provided in accordance with the invention, a method of combining multiple Really Simple Syndication (RSS) documents into a single master RSS document, the method comprising the steps of retrieving a plurality of RSS documents, scanning each RSS document to identify one or more individual elements therein, displaying the identified elements for selection by a user and aggregating identified elements selected by the user into the single master RSS document.

There is further provided in accordance with the invention, a method of combining multiple Really Simple Syndication (RSS) documents and non-RSS content into a single master RSS document, the method comprising the steps of retrieving a plurality of RSS documents and non-RSS documents, scanning each RSS document to identify one or more RSS based individual elements therein, scanning each non-RSS document to identify one or more non-RSS based individual elements therein, displaying the RSS based identified elements and the non-RSS based identified elements for selection by a user, converting non-RSS based identified elements selected by the user into RSS format, aggregating RSS based identified elements and converted non-RSS based identified elements selected by the user to into the single master RSS document.

There is also provided in accordance with the invention, a computer program product comprising a computer usable medium having computer usable program code for combining multiple Really Simple Syndication (RSS) documents into a single master RSS document, the computer program product including, computer usable program code for retrieving a plurality of RSS documents, computer usable program code for scanning each RSS document to identify one or more individual elements therein, computer usable program code for displaying the identified elements for selection by a user and computer usable program code for aggregating identified elements selected by the user to generate the single master RSS document.

### BRIEF DESCRIPTION OF THE DRAWINGS

The invention is herein described, by way of example only, with reference to the accompanying drawings, wherein:

FIG. 1 is a block diagram illustrating an example network incorporating a plurality of remote servers and local PCs, one of which executes the RSS aggregation application of the present invention;

FIG. 2 is a block diagram illustrating an example computer processing system architecture suitable for use with the present invention.

FIG. 3 is a block diagram illustrating an example document aggregator/combiner application constructed in accordance with the present invention in more detail;

FIG. 4 is a flow diagram illustrating the method of aggregating multiple RSS documents into a single RSS document in accordance with the present invention;

FIG. 5 is a flow diagram illustrating the method of generating RSS documents from non-RSS content sources;

FIG. 6 is an example screen shot of the GUI display of a plurality of objects found as a result of scanning of said non-RSS content sources.

FIG. 7 is a flow diagram illustrating the document rendering method of the present invention;

FIG. 8 is a flow diagram illustrating the automatic updating method of the present invention;

FIG. 9 is a diagram illustrating the record structure of the user content configuration database of the present invention;

FIG. 10 is a diagram illustrating the record structure of the document content element configuration database of the present invention; and

FIG. 11 is a flow diagram illustrating the record structure of the application element identification database of the present invention.

### DETAILED DESCRIPTION OF THE INVENTION

### Notation Used Throughout

The following notation is used throughout this document.

| Term | Definition |
|---|---|
| ASIC | Application Specific Integrated Circuit |
| CD-ROM | Compact Disc-Read Only Memory |
| CPU | Central Processing Unit |
| DSP | Digital Signal Processor |
| EEROM | Electrically Erasable Read Only Memory |
| FPGA | Field Programmable Gate Array |
| FTP | File Transfer Protocol |
| GUI | Graphical User Interface |
| HDL | Hardware Description Language |
| HTML | Hypertext Markup Language |
| HTTP | Hypertext Transfer Protocol |
| HTTPS | SSL secured HTTP |
| LAN | Local Area Network |
| NIC | Network Interface Card |
| PC | Personal Computer |
| PDA | Personal Digital Assistant |
| RAM | Random Access Memory |
| ROM | Read Only Memory |
| RSS | Really Simple Syndication |
| URI | Uniform Resource Identifier |
| URL | Uniform Resource Locator |
| USB | Universal Serial Bus |
| UWB | Ultra Wideband |
| WAN | Wide Area Network. |
| WLAN | Wireless Local Area Network |
| WWAN | Wireless Wide Area Network |
| XHTML | Extensible HyperText Markup Language |
| XML | Extensible Markup Language |
| XSTL | eXtensible Style Sheet Language Transformation |

The present invention is a system and method for combining or aggregating multiple RSS documents into a single master RSS document. The source RSS documents may include non-RSS documents from any content source. The invention provides a mechanism for converting non-RSS documents into RSS documents for inclusion in the single master RSS document. Any number and combination of RSS documents or content sources can be aggregated into the single master RSS document.

The aggregation application of the present invention provides a mechanism to identify the particular elements in each of the content sources and RSS documents that are to be aggregated into the master RSS document. The aggregation application provides a means for a user to indicate (1) the specific content sources and RSS documents to be included and (2) any filtering criteria to be applied to the content sources and/or RSS documents. This data is stored in a user content configuration database. The result is a collection of items that are stored in memory until the selection process is completed.

Once the user completes the selection process, the items stored in memory are retrieved and appended to the master RSS document. After all items are inserted and the master RSS document is generated, the user can elect to publish it or store it locally for future use. Note that the invention is not limited to any particular RSS format, as any suitable format may be used, e.g., RSS 1.0, 2.0, etc.

The aggregation application also provides a mechanism to generate RSS documents from non-RSS document content sources. In this case, the aggregation application fetches the non-RSS document and attempts to identify elements within the document. For each element identified, the aggregation application “highlights” the corresponding document code as a content element. The aggregation application then renders the document through a GUI whereby a user selects items they want represented in RSS format. Once selection is complete, the aggregation application generates an RSS representation of the items. The RSS representation of the items is then stored for subsequent insertion into the master RSS document. Note that when rendering the document, the GUI displays to the user the content of the document as represented by the highlighted code. The code itself is not displayed.

Some portions of the detailed descriptions which follow are presented in terms of procedures, logic blocks, processing, steps, and other symbolic representations of operations on data bits within a computer memory. These descriptions and representations are the means used by those skilled in the data processing arts to most effectively convey the substance of their work to others skilled in the art. A procedure, logic block, process, etc., is generally conceived to be a self-consistent sequence of steps or instructions leading to a desired result. The steps require physical manipulations of physical quantities. Usually, though not necessarily, these quantities take the form of electrical or magnetic signals capable of being stored, transferred, combined, compared and otherwise manipulated in a computer system. It has proven convenient at times, principally for reasons of common usage, to refer to these signals as bits, bytes, words, values, elements, symbols, characters, terms, numbers, or the like.

It should be borne in mind that all of the above and similar terms are to be associated with the appropriate physical quantities they represent and are merely convenient labels applied to these quantities. Unless specifically stated otherwise as apparent from the following discussions, it is appreciated that throughout the present invention, discussions utilizing terms such as ‘processing,’ ‘computing,’ ‘calculating,’ ‘determining,’ ‘displaying’ or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The invention can take the form of an entirely hardware embodiment, an entirely software embodiment or an embodiment containing a combination of hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium is any apparatus that can contain, store, communicate, propagate, or transport the program for use by or in connection with the instruction execution system, apparatus, or device.

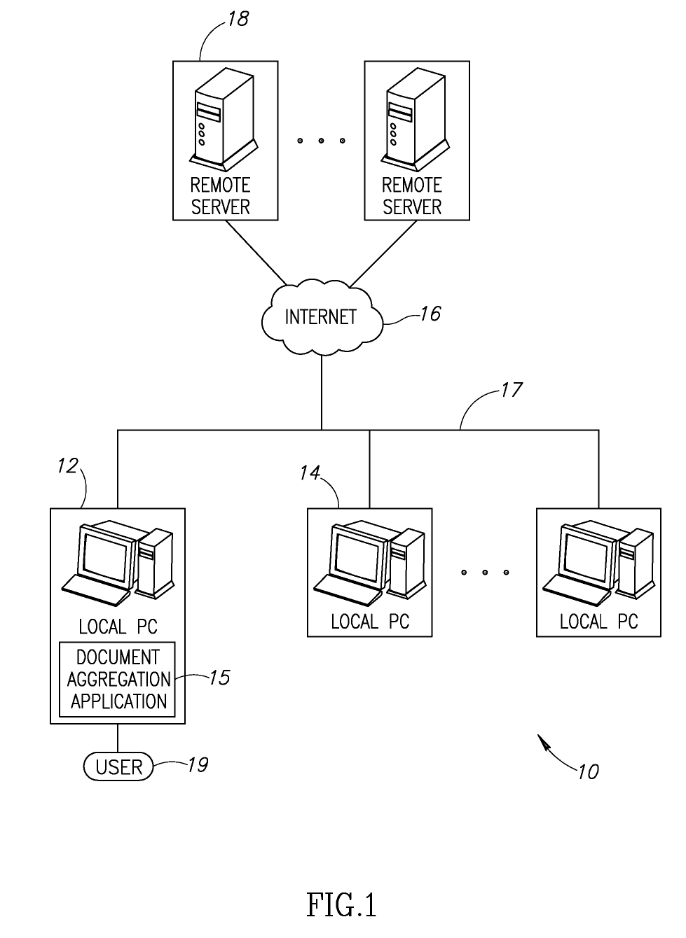

A block diagram illustrating an example network incorporating a plurality of remote servers and local PCs, one of which executes the RSS aggregation application of the present invention is shown in FIG. 1. The example network, generally referenced 10, comprises an Internet/WAN/WWAN cloud 16, one or more remote servers 18 and one or more local personal computers (PCs) 14 and a local PC 12 adapted to implement the document aggregation application 15 of the present invention. A user 19 is connected to and interacts with the aggregation application 15. Note that both the remote servers and local PC may comprise any type of computing device such as PC, laptop, notebook, palmtop, PDA, microcomputer, minicomputer, wired or wireless device, etc. without departing from the scope of the invention.

The RSS documents and non-RSS document content sources may reside anywhere in the network 10. For example, they may reside (1) on a remote server accessible via the Internet, (2) on a local PC accessible via the local LAN or WLAN 17, which connects the local PC 12 and 14 or (3) on the local PC that hosts the document aggregation application.

The document aggregation application of the present invention provides a user with the capability of combining both RSS documents and non-RSS document from different content sources. Note that in the example network presented herein, the manner of how the document aggregation application communicates with the local PCs and remote servers is not critical to the invention. Note that each RSS document or non-RSS content source to be aggregated into the master RSS document must have a URL or URI associated with it.

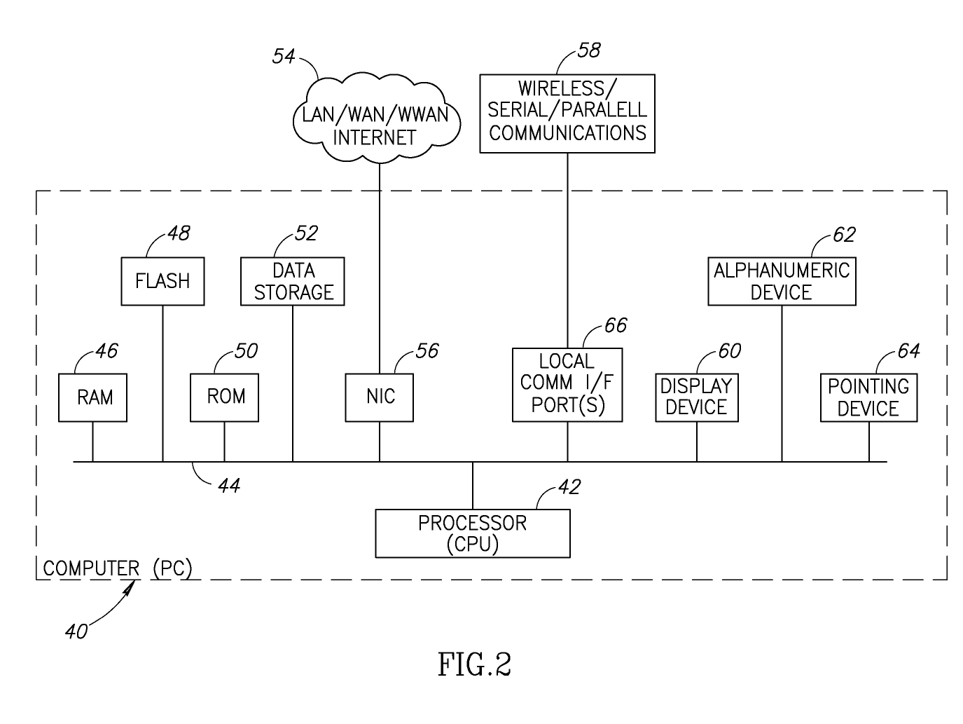

A block diagram illustrating an example computer processing system architecture suitable for use with the present invention is shown in FIG. 2. The computer system, generally referenced 40, comprises a processor 42 which may comprise a digital signal processor (DSP), central processing unit (CPU), microcontroller, microprocessor, microcomputer, ASIC or FPGA core. The system also comprises static read only memory 50 and dynamic main memory 46 all in communication with the processor. The processor is also in communication, via bus 44, with a number of peripheral devices that are also included in the computer system. Peripheral devices coupled to the bus include a display device 60 (e.g., monitor), alpha-numeric input device 62 (e.g., keyboard) and pointing device 64 (e.g., mouse, tablet, etc.)

The computer system is connected to one or more external networks such as a LAN or WAN 54 via communication lines connected to the system via a network interface card (NIC). A local communications I/F port(s) 66 provides connections to various wireless and wired links and serial and parallel devices. Examples include peripherals (e.g., printers, scanners, etc.), wireless links (e.g., Bluetooth, UWB, WiMedia, WiMAX, etc.) and wired links (e.g., USB, Firewire, etc.) The network adapters 56 and local communications I/F port(s) 66 coupled to the system enable the data processing system to become coupled to other data processing systems or remote printers or storage devices through intervening private or public networks. Modems, cable modem and Ethernet cards are just a few of the currently available types of network adapters.

The system also comprises magnetic or semiconductor based storage device 52 (e.g., RAM) for storing application programs and data. The system comprises computer readable storage medium that may include any suitable memory means, including but not limited to, magnetic storage, optical storage, semiconductor volatile or non-volatile memory, biological memory devices, or any other memory storage device.

Software adapted to implement the document aggregation mechanism is adapted to reside on a computer readable medium, such as a magnetic disk within a disk drive unit. Alternatively, the computer readable medium may comprise a floppy disk, removable hard disk, Flash memory 46, EEROM based memory, bubble memory storage, ROM storage, distribution media, intermediate storage media, execution memory of a computer, and any other medium or device capable of storing for later reading by a computer a computer program implementing the system and methods of this invention. The software adapted to implement the document aggregation mechanism of the present invention may also reside, in whole or in part, in the static or dynamic main memories or in firmware within the processor of the computer system (i.e. within microcontroller, microprocessor or microcomputer internal memory).

Other digital computer system configurations can also be employed to implement the document aggregation mechanism of the present invention, and to the extent that a particular system configuration is capable of implementing the system and methods of this invention, it is equivalent to the representative digital computer system of FIG. 2 and within the spirit and scope of this invention.

Once they are programmed to perform particular functions pursuant to instructions from program software that implements the system and methods of this invention, such digital computer systems in effect become special purpose computers particular to the method of this invention. The techniques necessary for this are well-known to those skilled in the art of computer systems.

It is noted that computer programs implementing the system and methods of this invention will commonly be distributed to users on a distribution medium such as floppy disk or CD-ROM or may be downloaded over a network such as the Internet using FTP, HTTP, or other suitable protocols. From there, they will often be copied to a hard disk or a similar intermediate storage medium. When the programs are to be run, they will be loaded either from their distribution medium or their intermediate storage medium into the execution memory of the computer, configuring the computer to act in accordance with the method of this invention. All these operations are well-known to those skilled in the art of computer systems.

### RSS and Non-RSS Document Aggregator/Combiner

The invention utilizes the really simple syndication (RSS) format to generate a single master document from a plurality of RSS documents. Every object that can be identified through a Uniform Resource Identifier (URI) or Uniform Resource Locator (URL) is a resource that can be embedded in an RSS document. An RSS document contains information about which information objects are to be found under a URI or URL. In addition, it can include a description of the resource and the individual information objects, the specification of a unique identifier for the objects and other information. It is also possible that the information object described may be completely embedded in the feed document.

All RSS documents are translated into serialized strings of characters and they use existing formats for content, i.e. simple text, HTML, XHTML, other XML vocabularies. RSS works independently of the internal structure of the information. Any item or collection of information can be the object of a RSS document. There are two kinds of information objects in all RSS formats, that is, collections of new information items and new individual items of information. The collections are called a channel (or a feed); an object within a collection is called an item or an entry. Both the channel and the item comprise content information, metadata, and information about the identification and linking of information objects.

An RSS document may describe another web resource, namely, the resource that is identified by the content of the link element. The presence of an element called a link, and with it, the ability to identify a document it refers to, distinguishes RSS documents from other web formats like HTML. The link element only states what the RSS document describes.

One of the characteristics of RSS is that the description is defined very generically making it is possible to include any type of content in the description. Thus, any kind of web content can be sampled and further distributed in an RSS document.

In addition, RSS, as a subset of XML, can be “translated” and “stylized” through eXtensible Style Sheet (XSTL) into HTML and thereby consumed by any application capable of rendering HTML content, such as a conventional web browser. This mechanism allows “serialized content” such as RSS to be embedded into an otherwise normal looking webpage and not a list of RSS data elements.

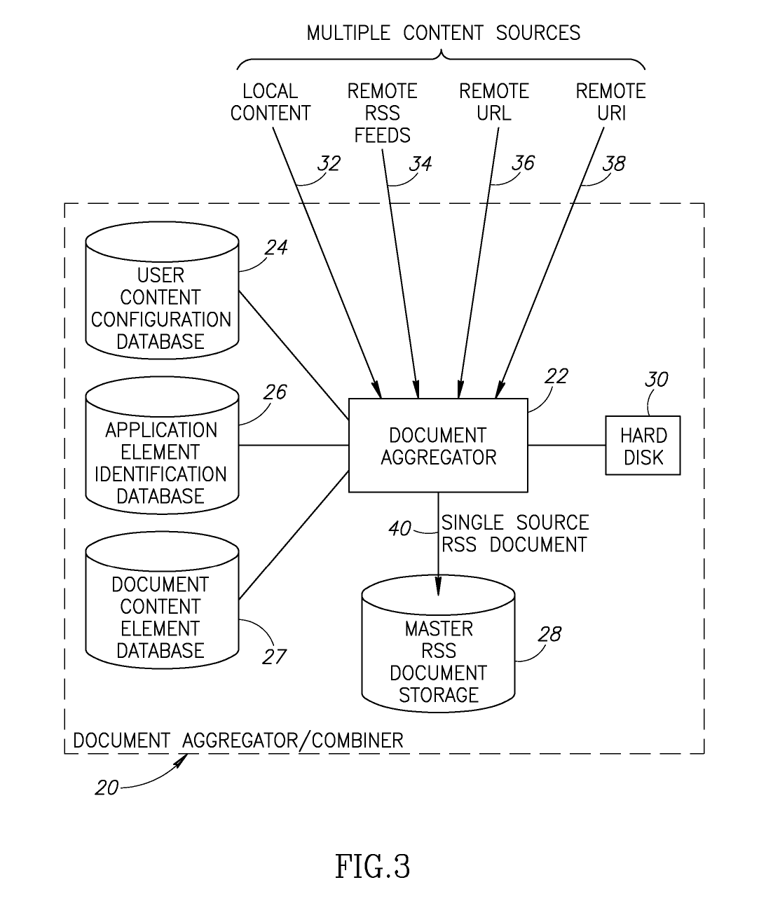

A block diagram illustrating an example document aggregator/combiner constructed in accordance with the present invention in more detail is shown in FIG. 3. The document combiner, generally referenced 20, comprises a document aggregator module 22, hard disk 30, master RSS document storage 28, user content configuration database 24, application element identification database 26 and document content element database 27.

In operation, the document aggregator is operative to combine RSS or non-RSS documents from a variety of sources into a single master RSS document that is stored in the master RSS document storage database 28. The documents to be combined can exist anywhere in the network and may comprise, for example, local content 32, remote RSS feeds 34, remote URLs 36 and/or remote URIs. Note that any combination of sources can be selected for aggregation into a single RSS document.

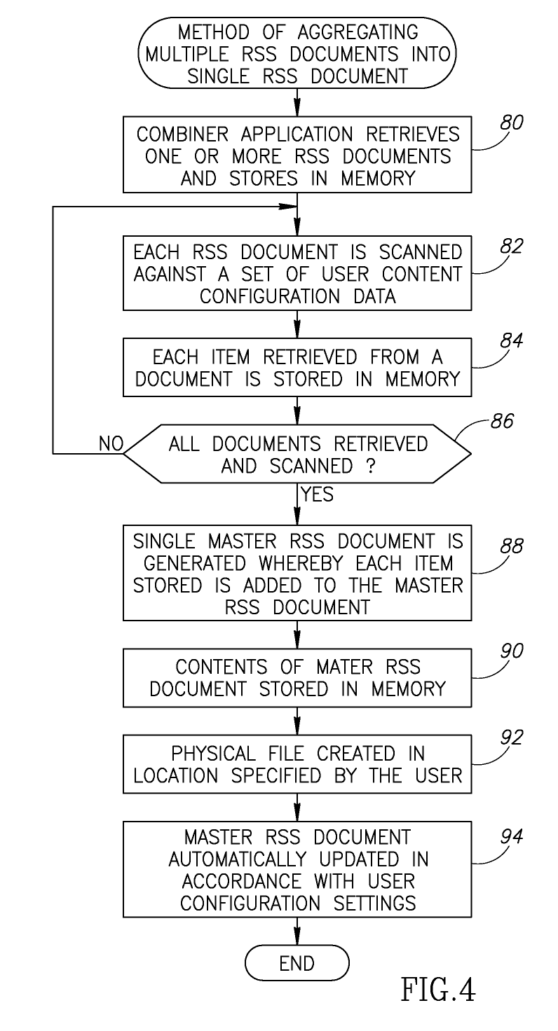

A flow diagram illustrating the method of aggregating multiple RSS documents into a single RSS document in accordance with the present invention is shown in FIG. 4. With reference also to FIG. 3, the process of aggregating multiple RSS documents will now be described in more detail. First, the aggregation application retrieves one or more RSS documents as indicated by a user and stored the documents in memory (step 80). If the aggregation application is located on a local PC, the user logs into the local PC to interact with the aggregation application. If the aggregation application is on a remote server the user logs into the server via a local PC connected to the network or Internet.

In one example embodiment, the location and name of each RSS document associated with the particular user is stored in a user content configuration database 24 (FIG. 3). The user and each RSS document are assigned unique IDs. Each record in the database also comprises a URI or URL that points to the specific RSS resource.

Note that RSS documents can comprise any of the following: (1) remote documents from other web sources that describe content items generated by web applications or web databases, (2) local documents representing application data on a PC, and (3) local documents representing file structures or physical files on a PC.

For each document that the application retrieves associated with the particular user, the aggregation application scans each document against a set of user content configuration data to determine what information is to be extracted from each specific document (step 82). The user content configuration data is stored in the user content configuration database and keyed to the user's ID or other equivalent item that uniquely identifies records associated with the user.

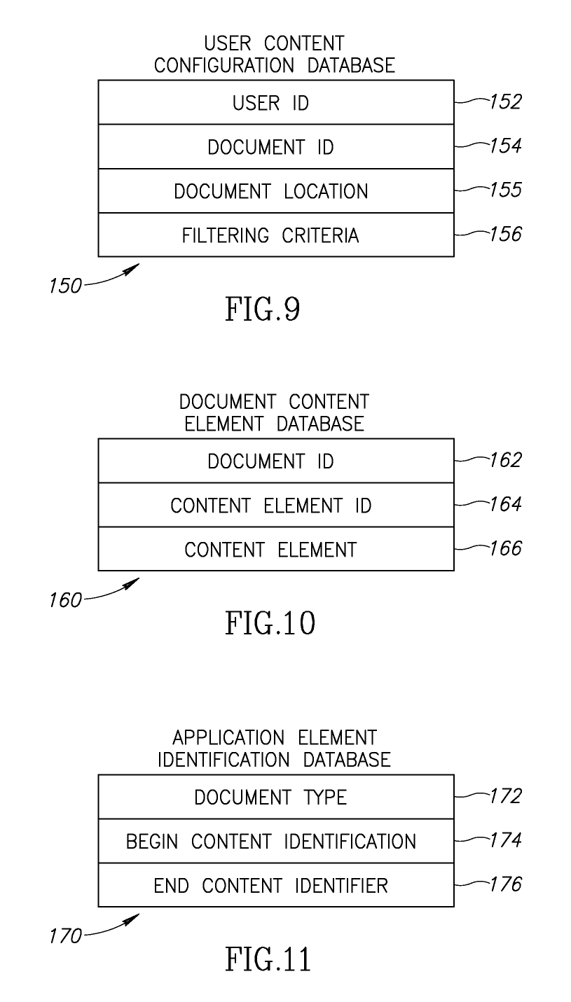

A diagram illustrating the record structure of the user content configuration database of the present invention is shown in FIG. 9. Each record, generally referenced 150, in the database comprises fields for a user ID 152, document ID 154, document location field 155 and filtering criteria 156. The user identifies and selects elements from each RSS document the wish to have included as part of the master RSS document. The selection of elements is performed via a Graphical User Interface (GUI) provided by the aggregation application and by applying an optional filtering criteria specified by the user. As an example of a filtering criteria, a user may identify several sources of news about relating to the sport of hockey. The user, however, rather than include all news about hockey, only wants news concerning the “San Jose Sharks.” This filtering criteria is stored in the user content configuration database as part of the configuration record associated with the user's ID. Alternatively, the user may choose not to specify any filtering criteria at all, in which case no filtering criteria are stored in the user content configuration database.

Each item that is retrieved (i.e. culled) from a document is stored in memory associated with the aggregation application (step 84). Storing documents in memory permits the aggregation application to process the retrieved documents quickly. In addition, storing the content items in memory permits quicker creation of the master RSS document once the selection process is complete.

Once all of the stored documents have been culled against the content configuration data associated with the user (step 86), the aggregation application generates a single master RSS document wherein each <Item> within the aggregation application memory is added (i.e. appended) sequentially to the master RSS document (step 88). In the event that there are no filtering criteria, the application stores all <Item> s from each RSS document and appends them to the master RSS document.

Once the master RSS document is created, the application stores the contents of the master document in the master RSS document storage database 28 (FIG. 3) as part of the user's unique record store (step 90). The aggregation application then generates a physical file and stores the document in the location specified by the user, either in response to a query or as indicated in the user content configuration database (step 92). Note that the location the master document is stored in may be the hard drive on the local PC or on a remote server.

Depending upon the user configuration settings, the aggregation application optionally automatically updates the master RSS document items by repeating the steps described supra (step 94). The master document is updated on a periodic basis or on any schedule specified by the user. After each update, the aggregation application generates a new master RSS document and stores the physical file at the specified location in accordance with the user's content configuration settings. Note that the physical file location may comprise the local or remote server hard drive.

### Generating RSS from a Non-RSS Content Source

As described supra, the present invention provides a mechanism for combining multiple RSS documents into a single master RSS document. The invention also provides a mechanism for combining non-RSS documents as well. In this case, the non-RSS document is first converted to an RSS document. Once converted, the process described in connection with FIG. 4 is used to aggregate multiple RSS documents into the master RSS document. The GIU provided by the aggregation application is used when a user elects to create an RSS document from a non-RSS content source. Examples of non-RSS documents include, for example, a web page, a static document such as a Microsoft Word or Adobe Acrobat file, etc.

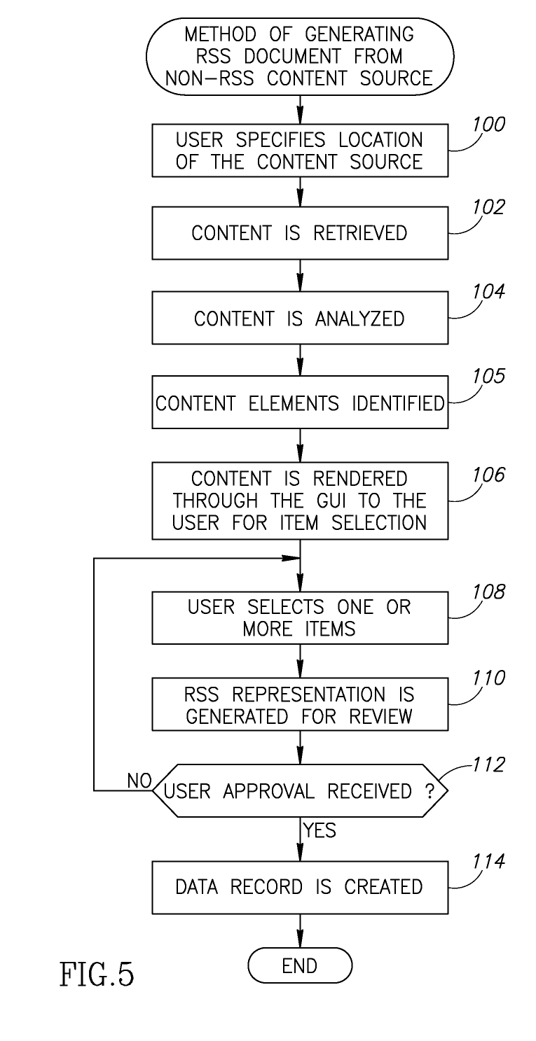

A flow diagram illustrating the method of generating RSS documents from non-RSS content sources is shown in FIG. 5. Utilizing the GUI provided by the aggregation application, the user first specifies the location of the content source (step 100). Note that the location of the content source may comprise a URL, URI or any other suitable location identifier. In addition to specifying the location of the content source, the user also indicates the type of content, i.e. the type of document. Examples of content types include Microsoft Word, Microsoft Excel, Adobe Acrobat, etc.

Once the location and type of the non-RSS document is provided, the aggregation application retrieves (i.e. fetches) the document (step 102) and loads it into memory where it is then analyzed (step 104). Note that the document is retrieved using any suitable means and any suitable protocol. For example, in the case of a URL, the document is retrieved using HTTP or HTTPs protocol. In the event the document is local, it can be retrieved through accessing the local hard drive.

The analysis process will now be described in more detail. First, the aggregation application performs a lookup in the application element identification database 26 (FIG. 3) based upon the type of document being accessed. The file extension of the document is the unique identifier used as an index or keyword into the database. Examples of file extensions include .html, .doc, .pdf, etc. The aggregation application then analyzes the ‘code’ or content making up the document using the application elements just retrieved from the database for that particular document type. The code or content is scanned for identifiable elements (step 105). For each element identified, the code or content is ‘highlighted’ and marked as a ‘content element’.

The application element identification database comprises information relating to the interaction of the aggregation application with a document and functions to identify content elements therein. Note that preferably, the user is not permitted to interact with this database. It is provided a priori as part of the installation process of the aggregation application. The database can be updated, however, when the aggregation application is updated with a newer version. Each record, generally referenced 170, comprises the following fields: a document type field 172 representing the extension type of the document (e.g., .doc, .html, etc.), a begin content identifier field 174 comprising a content identifier (e.g., <p> in HTML) that begins a content element, and an end content identifier field 176 comprising a content identifier (e.g., </p> in HTML) that ends a content element.

Once the analysis is complete, the aggregation application ‘renders’ the document through the GUI to the user whereby the user can select previously identified content elements within the document they wish to have represented as RSS (step 106).

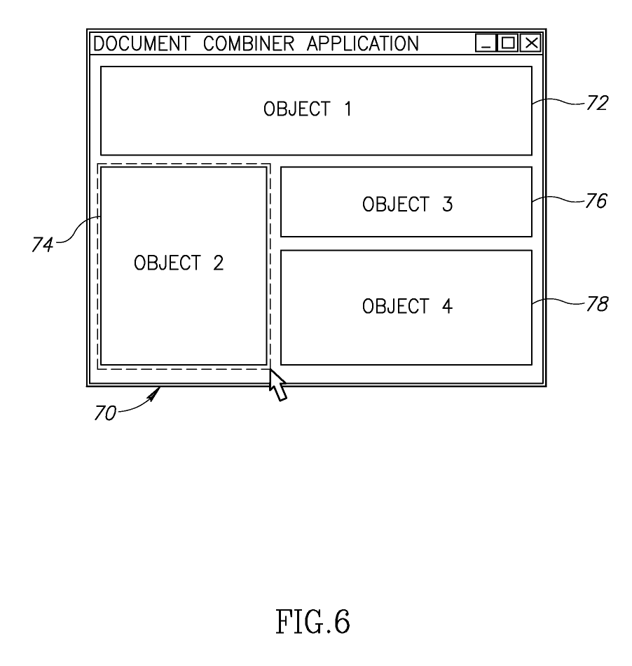

An example selection process made available to the user operates in the following manner. The aggregation application ‘surrounds’ the identified content element (or area of the content element) with an indicator such as a colored box or other type of indication to the user. For example, in the case of an .html document, paragraphs are surrounded by <p> and </p>. The indication is displayed on the page visible to the user as the user would see it and not as HTML code. FIG. 6 illustrates an example screen shot, generally referenced 70, displaying four objects 72, 74, 76, 78 as Object 1, Object 2, Object 3 and Object 4, respectively.

Alternatively, the aggregation application utilizes predetermined criteria to identify selectable content areas based upon the type of document. The predetermined criteria are pre-loaded and accessible to the aggregation application upon installation. Changes can be made subsequently either application upgrades or enhancements that the user downloads and installs or is downloaded/installed automatically by the aggregation application.

Once the application has identified definable content areas, the user selects (i.e. by clicking) one or more areas using the pointing device (e.g., mouse) within the GUI of the aggregation application (step 108). These areas are highlighted in some fashion to identify them as selectable.

After the user completes the selection process, and all selections have been indicated, the aggregation application generates an output RSS representation for review by the user (step 110). The user can then either (1) elect to return to the selection process for fine tuning, i.e. user approval is not received (step 112), or (2) decide to accepts the selections and proceed. If the user elects to continue, the aggregation application creates a new record in the document content element database 27 (FIG. 3) and stores the relevant data related to the document elements in the database (step 114).

This allows the aggregation application the ability to update the content associated with the selected elements. Depending upon the stored user configuration data (e.g., the frequency of time the aggregation application should check for updates to individual RSS documents and subsequently update the master RSS document), the aggregation application may retrieve that document again and, based upon the identified content elements as they are stored in the database, analyze the document again to update the corresponding RSS document with the most current content.

The user content configuration database 24 (FIG. 3) comprises information about the content sources identified by the user and how the application is to handle that content. The user is able to interact with this database through the GUI of the aggregation application through which the application saves changes to the affected records. The structure of the records stored in this database was described in detail supra in connection with FIG. 9.

A related database referred to as the document content element database is used to store the content elements. A diagram illustrating the record structure of the document content element database of the present invention is shown in FIG. 10. Each record, generally referenced 160, in the document content element database comprises the following fields: a unique document ID field 162 which comprises the document ID from the user content configuration database, a unique content element ID field 164 and a content element field 166 for storing the content element that was generated as part of the analysis of the user identified document. Note that a record is created for each content element selected by the user within the document.

Once the content elements are stored, the document (using the unique ID of the document) can now be used in the process of generating a master RSS document. Since the document has a unique ID, the application views the document simply as another independent RSS document that can be scanned against search criteria when generating a master RSS document.

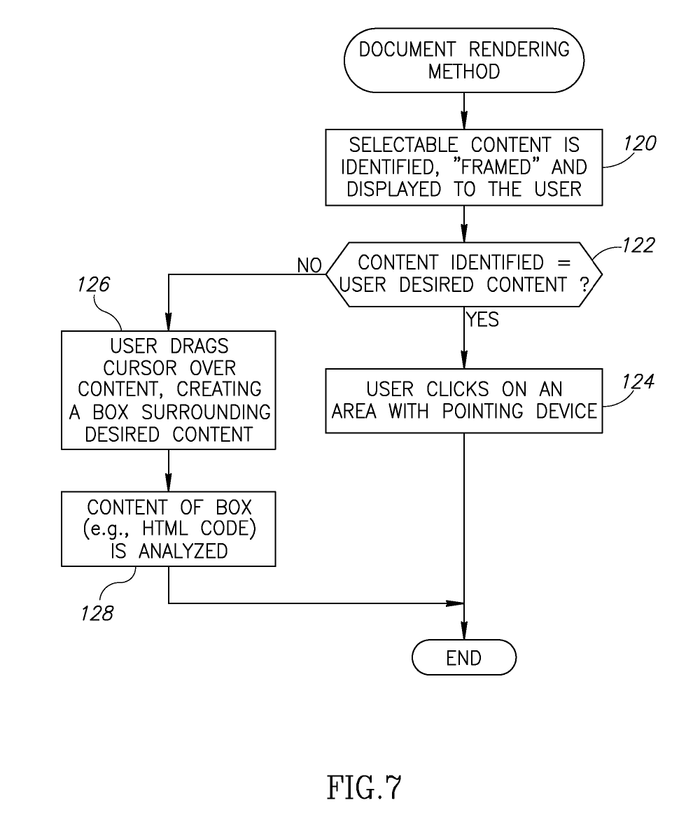

The document rendering process (step 106 in the method of FIG. 5) will now be described in more detail. A flow diagram illustrating the document rendering method of the present invention is shown in FIG. 7. As described supra, once content elements are identified, the aggregation application ‘renders’ the document through the GUI to the user whereby the user can select previously identified content elements within the document they wish to have represented as RSS. The selectable content elements are ‘framed’ or ‘surrounded’ by suitable code to display a box or other indication to the user that the content element is selectable (step 120). If the content identified is the content desired by the user to be inserted in the master document (step 122), the user simply clicks on an area with the pointing device (e.g., the mouse) to indicate this (step 124). If, however, the content identified is not the content desired by the user to be inserted in the master document (step 122), than the aggregation application provides a mechanism to allow the user to drag the cursor over the desired content to be included in the master document, creating a box around the desired content (step 126). The contents of the box selected is then analyzed and interpreted by examining the ‘code’ (e.g., HTML code representing the selected portion of a web page, etc.) (step 128). The process continues with the step of generating the RSS representation of the selected area for review (step 110 of FIG. 5).

As described supra, the document aggregation application of the invention comprises a mechanism for generating RSS documents from non-RSS content sources. The aggregation application of the present invention also comprises the ability to generate (1) RSS documents representing local folder structures and/or the files therein and (2) RSS documents representing application data. A mechanism for generating (1) RSS documents representing local folder structures and/or the files therein and (2) RSS documents representing application data suitable for use with the present invention is described in more detail in U.S. application Ser. No. 11/458,955, filed Jul. 20, 2006, entitled “System And Method For Delivery of PC Content Through a Server Based Relay System Using Really Simple Syndication”, hereby incorporated by reference in its entirety.

### Automatic Updating Method

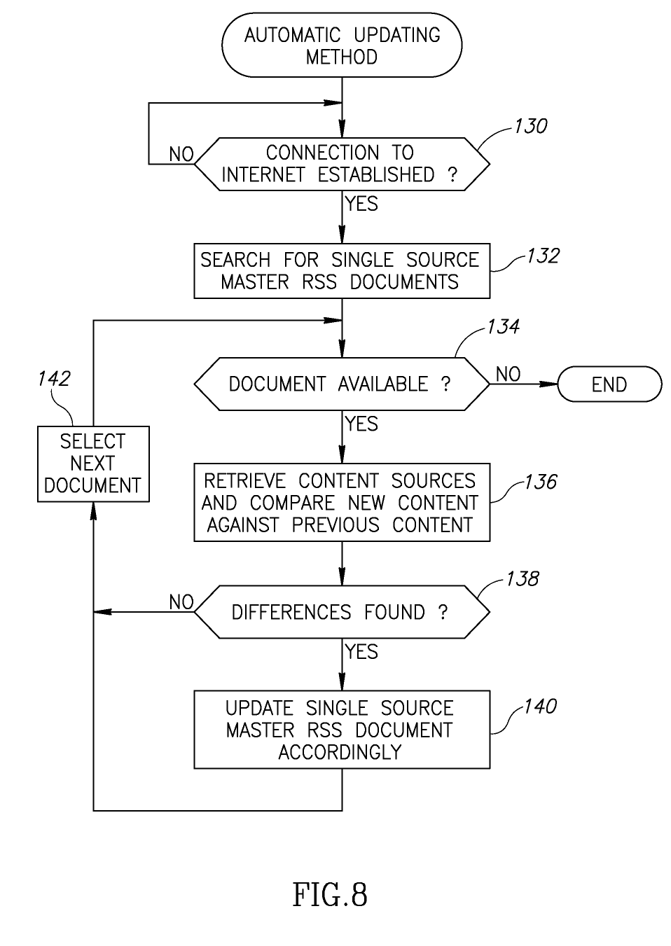

The automatic updating method of the present invention will now be described in more detail. A flow diagram illustrating the automatic updating method of the present invention is shown in FIG. 8. This method is optionally performed by the aggregation application. After a master RSS document is generated, the aggregation application can optionally update the master document whenever an Internet connection is established and detected and at predetermined intervals. In the case the master document is published on a remote server, the aggregation application is operative to update that document whenever an Internet connection is established and detected. The updated document is upload using a technique, e.g., FTP, etc. specified by the user as part of the publishing process.

A master document is identified as part of the user's configuration data store din the user content configuration database. First, it is checked if a connection to the Internet is available (step 130). The aggregation application is operative to detect that the computer on which it is installed has a connection to the Internet. If no connection is detected, the aggregation application waits while monitoring for the connection. When that network connection is detected, the aggregation application examines its logs to determine the master RSS documents that have been generated (step 132). It then accesses the master RSS document storage database to see if the parameters (e.g., corresponding document ID) for that master RSS document include automatic update .

If the parameters include automatic update (step 134), the aggregation application examines the remainder of the record for that master RSS document ID. Using each URL or URI for each content element, the aggregation application attempts to access the content object. If the content cannot be retrieved, the user is notified through a pop-up dialog.

Once all content sources have been accessed, the aggregation application retrieves additional information from the document content element database regarding each element for each content object and, analyzing the new or current document, compares the data (keyword comparison) against the data stored from the previous update (step 136).

If any differences are found (step 138), i.e. new content is identified, the aggregation application updates the data in the document content element database and also updates the master RSS document database accordingly, appending a date/time stamp as necessary (step 140). The next document is then selected (step 142) and additional documents are available (step 134) the method continues with step 136. If no further documents are available, the method terminates.

Note that the RSS 2.0 format standard can be modified to permit a more precise representation of Items within an RSS feed via the use of an Item ID. For example, a representation of an example item using the current RSS 2.0 format specification is as follows:

<item>
<title>Name of file or directory</title>
<description>Empty</description>
<enclosure/>c://my documents/documents/work/document.doc
</enclosure>
</item>

An example modification exhibiting a more precise representation of an Item that comprises an Item ID is as follows:

<item #114456>
<title>Name of file or directory</title>
<description>Empty</description>
<enclosure/>c://my documents/documents/work/document.doc
</enclosure>
</item #114456>

In a PC that implements the document aggregation application of the present invention, the parser would recognize the ‘#’ and interpret the string of characters following it to the ending ‘>’ as the Item ID. The parsed Item ID functions to uniquely identify RSS elements received from different content sources.

In a PC that does not implement the document aggregation application of the invention, a parser would ignore the ‘#’ and the characters following it in the RSS record, thus permitting backward compatibility with PCs that do not implement the invention.

In alternative embodiments, the methods of the present invention may be applicable to implementations of the invention in integrated circuits, field programmable gate arrays (FPGAs), chip sets or application specific integrated circuits (ASICs), DSP circuits, wired or wireless implementations and other communication system products.

It is intended that the appended claims cover all such features and advantages of the invention that fall within the spirit and scope of the present invention. As numerous modifications and changes will readily occur to those skilled in the art, it is intended that the invention not be limited to the limited number of embodiments described herein. Accordingly, it will be appreciated that all suitable variations, modifications and equivalents may be resorted to, falling within the spirit and scope of the present invention.

What is claimed is:

1. A method of aggregating a plurality of content sources into a single master Really Simple Syndication (RSS) document, said method comprising the steps of:
retrieving a plurality of content sources;
scanning each content source against user content configuration data to extract one or more items therefrom;
storing each item extracted in memory; and
combining said items stored in memory into a single master RSS document.

2. The method according to claim 1, wherein said content source comprises an RSS document.

3. The method according to claim 1, wherein said content source comprises a non-RSS document that is first converted to RSS format by the steps of:
determining a document type of said non-RSS document;
analyzing the contents of said document in accordance with its type to identify one or more elements; and
highlighting each element identified as a content element.

4. The method according to claim 3, wherein said step of determining comprises the steps of retrieving said document type from an application element identification database in accordance with said document type.

5. The method according to claim 3, wherein said step of analyzing comprises the steps of:
retrieving one or more application elements corresponding to said document type from an application element identification database; and
examining code making up said document utilizing said one or more application elements retrieved from said application element identification database.

6. The method according to claim 1, wherein said content source comprises a non-RSS document that is first converted to RSS format by the steps of:
analyzing said non-RSS document to identify one or more content elements;
rendering said non-RSS document through a graphical user interface (GUI) to display a one or more content areas for selection by a user to be represented as RSS; and
generating an RSS representation of said one or more content areas selected by said user.

7. The method according to claim 6, wherein said step of rendering comprises the step of surrounding displayed content areas with an indication to indicate to said user the availability for selection of said content areas.

8. The method according to claim 1, wherein said step of scanning comprises the steps of:
displaying elements from each content source via a graphical user interface (GUI) to a user for selection in said master RSS document; and
storing any uniform resource locaters (URLs), uniform resource indicators (URIs) and filtering criteria used to identify all or a portion of said plurality of elements displayed to said user for inclusion in said master RSS document.

9. The method according to claim 1, wherein said step of combining comprises the step of appending each item stored in memory sequentially to said master RSS document.

10. The method according to claim 1, further comprising the step of storing the contents of said master RSS document in a user specified file location.

11. The method according to claim 1, further comprising the step of updating the contents of said master RSS document at user specified time intervals.

12. A method of combining a plurality of Really Simple Syndication (RSS) documents into a single master RSS document, said method comprising the steps of:
retrieving a plurality of RSS documents;
scanning each RSS document to extract one or more items therefrom utilizing user content configuration data to indicate the information to be extracted; and
combining said extracted items into a single master RSS document.

13. The method according to claim 12, wherein said plurality of RSS documents comprise one or more non-RSS documents converted to RSS documents by the steps of:
determining a document type of said non-RSS document;
analyzing the contents of said document in accordance with its type to identify one or more elements; and
highlighting each element identified as a content element.

14. The method according to claim 13, wherein said step of determining comprises the steps of retrieving said document type from an application element identification database in accordance with said document type.

15. The method according to claim 13, wherein said step of analyzing comprises the steps of:
retrieving one or more application elements corresponding to said document type from an application element identification database; and
examining code making up said document utilizing said one or more application elements retrieved from said application element identification database.

16. The method according to claim 12, wherein said plurality of RSS documents comprise one or more non-RSS documents converted to RSS documents by the steps of:
analyzing said non-RSS document to identify one or more content elements;
rendering said non-RSS document through a graphical user interface (GUI) to display a one or more content areas for selection by a user to be represented as RSS; and
generating an RSS representation of said one or more content areas selected by said user.

17. The method according to claim 16, wherein said step of rendering comprises the step of surrounding displayed content areas with an indication to indicate to said user the availability for selection of said content areas.

18. The method according to claim 12, wherein said step of scanning comprises the steps of:
displaying elements from each RSS document via a graphical user interface (GUI) to a user for selection in said master RSS document; and
storing any uniform resource locaters (URLs), uniform resource indicators (URIs) and filtering criteria used to identify all or a portion of said plurality of elements displayed to said user for inclusion in said master RSS document.

19. The method according to claim 12, wherein said step of combining comprises the step of appending each item stored in memory sequentially to said master RSS document.

20. The method according to claim 12, further comprising the step of storing the contents of said master RSS document in a user specified file location.

21. The method according to claim 12, further comprising the step of updating the contents of said master RSS document at user specified time intervals.

22. A computer program product, comprising:
a computer usable medium having computer usable program code for combining a plurality of Really Simple Syndication (RSS) documents into a single master RSS document, said computer program product including;
computer usable program code for retrieving a plurality of RSS documents;
computer usable program code for scanning each RSS document to extract one or more items therefrom utilizing user content configuration data to indicate the information to be extracted; and
computer usable program code for combining all extracted items into a single master RSS document.

23. The computer program product according to claim 22, wherein said plurality of RSS documents comprise one or more non-RSS documents converted to RSS documents by the steps of:
determining a document type of said non-RSS document;
analyzing the contents of said document in accordance with its type to identify one or more elements; and
highlighting each element identified as a content element.

24. The computer program product according to claim 22, wherein said plurality of RSS documents comprise one or more non-RSS documents converted to RSS documents by the steps of:
analyzing said non-RSS document to identify one or more content elements;
rendering said non-RSS document through a graphical user interface (GUI) to display a one or more content areas for selection by a user to be represented as RSS; and
generating an RSS representation of said one or more content areas selected by said user.

25. The computer program product according to claim 22, wherein said computer usable program code for step of scanning comprises:
computer usable program code for displaying elements from each RSS document via a graphical user interface (GUI) to a user for selection in said master RSS document; and
computer usable program code for storing any uniform resource locaters (URLs), uniform resource indicators (URIs) and filtering criteria used to identify all or a portion of said plurality of elements displayed to said user for inclusion in said master RSS document.

26. The computer program product according to claim 22, wherein said computer usable program code for combining comprises computer usable program code for appending each item stored in memory sequentially to said master RSS document.

27. The computer program product according to claim 22, further comprising computer usable program code for storing the contents of said master RSS document in a user specified file location.

28. The computer program product according to claim 22, further comprising computer usable program code for updating the contents of said master RSS document at user specified time intervals.

29. A method of combining multiple Really Simple Syndication (RSS) documents into a single master RSS document, said method comprising the steps of:
retrieving a plurality of RSS documents;
scanning each RSS document to identify one or more individual elements therein;
displaying said identified elements for selection by a user; and
aggregating identified elements selected by said user into said single master RSS document.

30. The method according to claim 29, further comprising the step of applying content filtering to said plurality of RSS documents.

31. The method according to claim 29, wherein said step of displaying comprises displaying each RSS document with said identified elements highlighted for selection by said user.

32. A method of combining multiple Really Simple Syndication (RSS) documents and non-RSS content into a single master RSS document, said method comprising the steps of:
retrieving a plurality of RSS documents and non-RSS documents;
scanning each RSS document to identify one or more RSS based individual elements therein;
scanning each non-RSS document to identify one or more non-RSS based individual elements therein;
displaying said RSS based identified elements and said non-RSS based identified elements for selection by a user;
converting non-RSS based identified elements selected by said user into RSS format;
aggregating RSS based identified elements and converted non-RSS based identified elements selected by said user to into said single master RSS document.

33. A computer program product, comprising:
a computer usable medium having computer usable program code for combining multiple Really Simple Syndication (RSS) documents into a single master RSS document, said computer program product including;
computer usable program code for retrieving a plurality of RSS documents;
computer usable program code for scanning each RSS document to identify one or more individual elements therein;
computer usable program code for displaying said identified elements for selection by a user; and
computer usable program code for aggregating identified elements selected by said user to generate said single master RSS document.
